(19) United States
(12) Patent Application Publication
(10) Pub. No.: US 2014/0106033 A1
(43) Pub. Date: Apr. 17, 2014

(54) Beverage Supplement and Method for Making the Same

(71) Applicant: Matthew P. Roberts, Ipswich, MA (US)

(72) Inventor: Matthew P. Roberts, Ipswich, MA (US)

(21) Appl. No.: 14/051,098

(22) Filed: Oct. 10, 2013

Related U.S. Application Data
(60) Provisional application No. 61/713,403, filed on Oct. 12, 2012.
(60) Provisional application No. 61/723,761, filed on Nov. 7, 2012.

(51) Int. Cl. A23L 2/56; C12G 3/00; A23F 3/40; A23F 5/46

(52) U.S. Cl. CPC A23L 2/56; A23F 5/46; C12G 3/00; A23F 3/40
USPC 426/100; 426/594; 426/120; 426/393; 426/592; 426/597

(57) ABSTRACT

A beverage supplement and method for making the same is disclosed. In some embodiments the beverage supplement is comprised of a first frozen composition made from at least one additive mixed with at least one liquid and a second frozen composition made from at least one additive mixed with at least one liquid, wherein the resulting frozen compositions may have different/varying surface areas, shapes, volumes, flavors, and concentrations. Varying the combination of surface areas, shapes, volumes, formulas, flavors, and concentrations of frozen compositions influences the duration of complete liquefaction and the release of additives, allowing a user to create an iced beverage with greater flavor control.

### BACKGROUND OF THE INVENTION

1. Field of the Invention

The present embodiments relate generally to packaging frozen compositions and more particularly to packaging frozen compositions for the purpose of making a beverage therewith.

2. Description of the Prior Art

The creation of an iced beverage is an elementary concept. When ice, or frozen water, is in contact with a liquid heat transfers often lower the temperature of the liquid, making it more enjoyable for some consumers. For years, advertisers have used the term “ice cold” to enhance beverage sales. Many consumers prefer freely floating ice in a drink for a variety of reasons, including its chilling effect. Unfortunately, when frozen water melts in a beverage, the composition of the liquid changes and becomes diluted, or in other words, the ratio of additives to the volume of the liquid, or concentration of the additives, decreases. Some consumers practice freezing compositions other than pure water to add to a beverage in attempt to mitigate the undesirable effects of composition and taste change, however, the freezing process often takes hours. A need therefore exists for a more convenient way to create an iced cold beverage having mitigated dilution effects.

### SUMMARY OF THE INVENTION

Disclosed herein is a beverage supplement and method for making the same, where the beverage supplement is comprised of a plurality of beverage enhancers that when frozen may vary in shape, volume, surface area, composition, flavor, concentration and so forth.

In one embodiment a first frozen composition comprising at least one additive and at least one liquid, or base liquid, may be created. A second frozen composition comprising at least one additive mixed with at least one liquid may also be created, the resulting frozen compositions having a combination of shape and volume distinct of each other, and varying flavors and/or concentrations. The frozen compositions may be added to a liquid and thereby create an iced or partially frozen beverage.

In another embodiment layered frozen compositions may be created by freezing a first composition, having at least one additive and one liquid, into a specified shape and volume. A second layer may then be created by freezing a second composition, having a different additive, liquid or concentration of an additive, around the frozen first composition and thereby creating a frozen solid having two distinct layers of compositions. In additional embodiments, the process may be repeated to create additional layers. In embodiments having layered frozen compositions, the plurality of layered compositions may be added to a liquid and thereby create an iced or partially frozen beverage.

In yet another embodiment, a single, first composition, may be frozen into ice portions with at least one varying combination of shape, volume, and surface area. This single composition, frozen into at ice portions with at least one varying combination of shape, volume, and surface area, may be added to a liquid and thereby create an iced or partially frozen beverage.

In some embodiments the frozen compositions may be packaged, stored, and distributed below a certain temperature that allows the portions to remain frozen, maintain their solid form, and not mix. In other embodiments, the compositions may be packaged, stored, and distributed in a liquid state above a certain temperature with a divider that prevents the compositions from mixing. In such embodiments, consumers may purchase the non-frozen compositions and place the packaging into a freezing device.

In one embodiment the package used to store the frozen compositions is comprised of a ready-to-use container, where only a liquid is needed

In some instances, the packaged frozen compositions may be added to a container already having water (or another liquid) or, in alternative embodiments, the frozen compositions may be added to a container before the liquid. During the liquification, liquefaction, or melting of the frozen compositions an iced beverage with a desired range of flavors for drinking is created. It is contemplated herein that the length of time it takes for the complete liquefaction of each frozen composition, having varying additives, liquids and/or concentrations of an additive, may be influenced by its distinct combination of shape and volume. It is also contemplated that as the frozen compositions liquefy, or melt, into a liquid they expel their additives. Therefore, adjusting the combination, or combinations, of shape and volume of distinct frozen compositions controls the release of additives into a liquid during the liquefaction process and may be used for creating a desirable iced beverage. The liquefactions of a plurality of frozen compositions, with varying combinations of additives or liquids, and distinctly established combinations of shape and volume, into a liquid may be used to control a range of flavors of an iced beverage. The liquefaction of a plurality of frozen compositions, with varying concentrations of an additive and distinctly established combination of shape and volume, into a liquid may be used to mitigate the dilution of a flavor of an iced beverage.

It is also contemplated that in certain environments the progression of liquefaction that produces the desired flavor of a beverage may occur almost immediately. For example, if a first frozen composition needs to liquefy completely into specified amount of a liquid to bring the liquid to a desirable flavor, the liquid may be heated above a specified temperature that melts the first frozen composition almost instantly once submerged. The other frozen composition, or compositions, may have a combination of volume or shape that influences a longer duration for complete liquefaction. Alternatively, shaking, or other forms of inducing energy, may expedite the complete liquefaction of the frozen compositions.

Therefore, the method and beverage supplements disclosed herein may be used to create a desirable iced beverage experience in quick, convenient manner.

### BRIEF DESCRIPTION OF THE DRAWINGS

FIG. 1 is a flow diagram showing on embodiment of a method for packaging frozen compositions and creating a beverage therewith.

FIG. 2 is an elevated view illustrating various embodiments of frozen compositions.

FIG. 3 is an elevated view showing frozen compositions of various volumes, compositions, and surface areas in a beverage container.

FIGS. 4A-D illustrates various embodiments and shapes of frozen compositions.

FIG. 5 Is an elevated view illustrating various embodiments of different compositions packaged with a divider to prevent mixing.

### DETAILED DESCRIPTION OF THE PREFERRED EMBODIMENT

A description of example embodiments of the invention follows. The teachings of all patents, published applications, and references cited herein are incorporated by reference in their entirety. While the invention has been particularly shown and described with references to example embodiments thereof, it will be understood by those skilled in the art that various changes in form and details may be made therein without departing from the scope of the invention encompassed by the appended claims. As noted above, aspects and embodiments described herein relate generally to the field of packaging frozen compositions for the purpose of making a beverage therewith.

For purposes of this disclosure, the term composition means a proportional physical or chemical make-up of combined parts or ingredients. As disclosed herein, a composition may comprise at least one additive and at least one liquid. Additionally, for purposes of this disclosure, a composition becomes more, or higher, concentrated when it has been reduced in volume or bulk by the removal of a liquid. Alternatively, concentration refers to the ratio of an additive or additives to the volume of a composition. For example, if a composition is made of one part additive and two parts liquid, the concentration, or ratio of the additive to the volume of the liquid, will be higher, or increase, if one part water is removed, leaving a new composition having one part additive and one part water. Compositions may be unique from one another if they have a different combination of additives or liquids, or the concentration varies. It is contemplated in one embodiment where a composition is comprised of at least one liquid (which may be viewed as a non-dry additive) and a base liquid. Here concentration would be a function of the liquid to base liquid ratio, wherein removal of the base liquid would increase the concentration.

Further, the term beverage may include any potable liquid (including water) and may more specifically, include coffee, tea, juices, beer, cocktails, sports drinks, energy drinks, carbonated drinks, soda, milk, gin, vodka, beer, rum, whiskey, tequila, brandy, liqueurs, wine, champagne, ale, cider, lager, vermouth, any combination thereof, or any other potable liquid other than pure water. Additionally, the term additive means any edible and/or potable material commonly used to enhance the composition of a liquid, including: coffee, milk, cream, sugar, artificial flavors, natural flavors, artificial sweetener, natural sweeteners, protein powder, vitamins, calcium, cinnamon, honey, chromium, cranberry, echinacea, fish oil, garlic, ginger, ginko, ginseng, glucoseamine, green tea, fruit tea, herbal tea, iron, magnesium, potassium, melatonin, niacin, omega-3 fatty acids, saw palmetto, selenium, valerian, zinc, caffeine, creatine, pre-natal vitamins, multi-vitamins, medicines, fruits, vegetables, any combination thereof, or any other edible and/or potable material commonly used in the art. In some embodiments, a liquid may be defined as an additive and, in other embodiments, the same liquid may not be defined as an additive. Furthermore, in additional embodiments, a liquid may be defined as an additive in a first composition and may not be defined as an additive in a second composition.

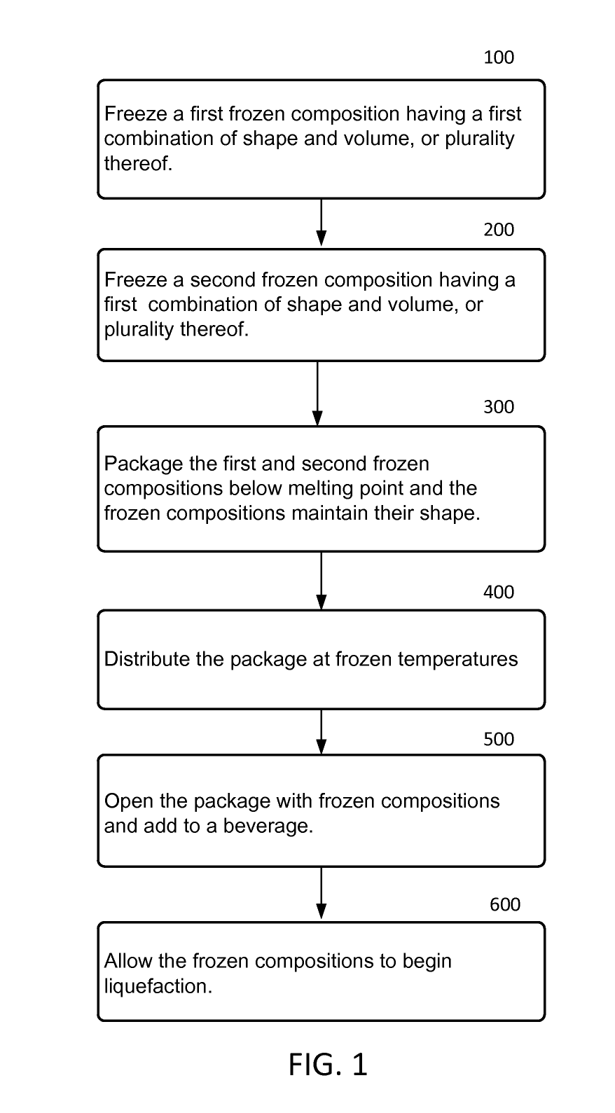

FIG. 1 illustrates a method for packaging frozen compositions and creating a beverage therewith. As disclosed herein, a frozen composition may be created when one or more additives are mixed with a base liquid, using a variety of methods, including brewing, and are frozen. In the cases where an additive produces a residue, i.e., coffee grounds and/or tea leaves, the composition may be filtered before freezing to remove any unused matter. In step 100, a first frozen composition having a first combination of shape and volume, or plurality thereof, is created. In step 200, a second frozen composition having a second combination of shape and volume, or plurality thereof, is created. In step 300, the first and second frozen compositions may be packaged and stored at a predetermined temperature, wherein the temperature is selected so the frozen compositions remain frozen and maintain their solid state and unique combinations of shape and volume. In step 400, the package containing the frozen compositions is distributed in conditions and temperatures so the frozen compositions maintain their solid state and unique combinations of shape and volume. In step 500, the frozen compositions may be added into a beverage container having a liquid. In step 600, the frozen compositions are mixed, shaken, and/or stirred within the liquid wherein the frozen compositions begin to melt, expelling the respective additives into the liquid, and create the desired beverage experience.

In accordance with the present disclosure, compositions are created having at least one predetermined and pre-calculated additive dispersed in at least one liquid and are then frozen. In some embodiments, the unique frozen compositions used to create an iced beverage may be created having varying combinations of shape and volume. For example, one composition may have one part cream, one part sugar, two parts coffee, and one part water; while a second composition may have one part cream, one part sugar, four parts coffee, and one part water. In additional beverages, additional unique compositions are also contemplated herein.

In additional embodiments, frozen compositions may be formed in layers. In such embodiments, different layers may have a different composition. For example, frozen compositions may be formed using a plurality of layers such that the outermost layer may be formed by freezing a composition with a high concentration of an additive and wherein the concentration of the additive decreases with each layer so the core has the lowest concentration.

Although this present disclosure frequently mentions using a plurality of frozen compositions to create an iced beverage, it is contemplated within the scope of this disclosure that a single, or first, composition, may be frozen into ice portions with at least one varying combination of shape, volume, and surface area, and then may be added to a liquid, without another frozen composition, to create an iced or partially frozen beverage.

It is contemplated herein that the frozen compositions may have varying additive to volume ratios. For example, a frozen composition may range from a ratio of 15 parts additive and 1 part liquid to a ratio having 1 part additive and 15 parts liquid. In other embodiments, a frozen composition may range from a ratio of 10 parts additive and 1 part liquid to a ratio having 1 part additive and 10 parts liquid. While in yet additional embodiments, a frozen composition may range from a ratio of 5 parts additive and 1 part liquid to a ratio having 1 part additive and 5 parts liquid, and further a frozen composition may range from a ratio of 3 parts additive and 1 part liquid to a ratio having 1 part additive and 3 parts liquid.

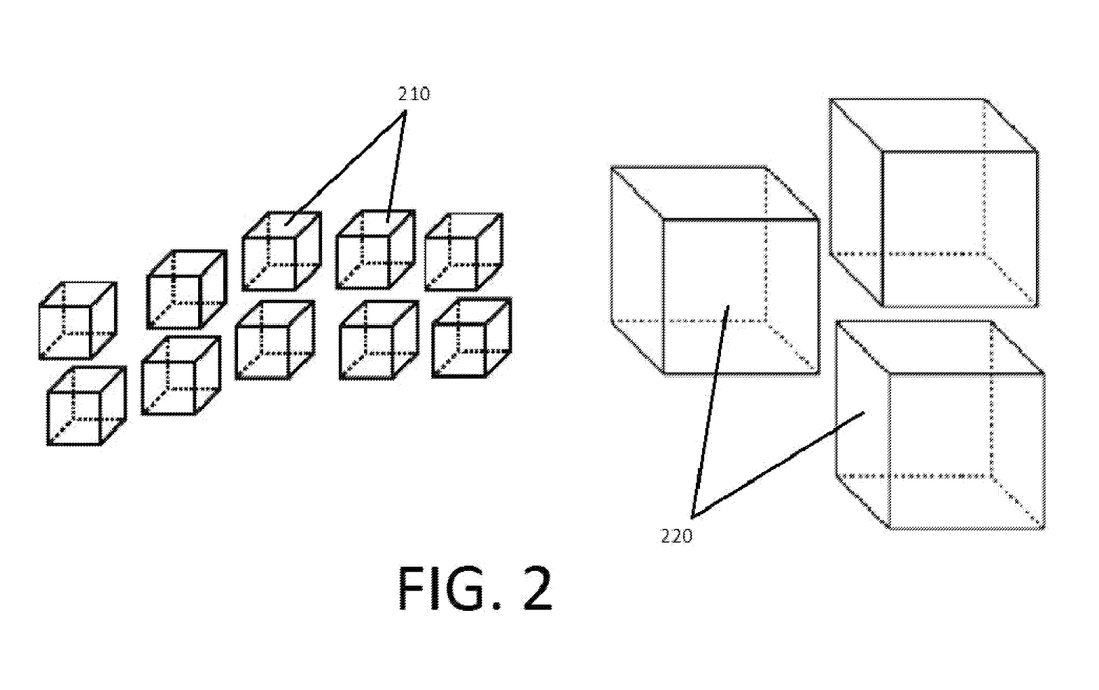

Now referring to FIG. 2, in some embodiments disclosed herein, frozen compositions may be formed having various combinations of shape and volume. In FIG. 2, the frozen compositions may have smaller volumes 210 or larger volumes 220 relative to one another. In additional embodiments, beverages may be created with frozen compositions having one of three combinations of shape and volume. In yet additional embodiments, frozen compositions comprising more than three different combinations of shape and volume may be used to create a single beverage. As disclosed herein, the unique combinations of shape and volume influence the time it takes each frozen composition to liquefy entirely, controlling the release of additives.

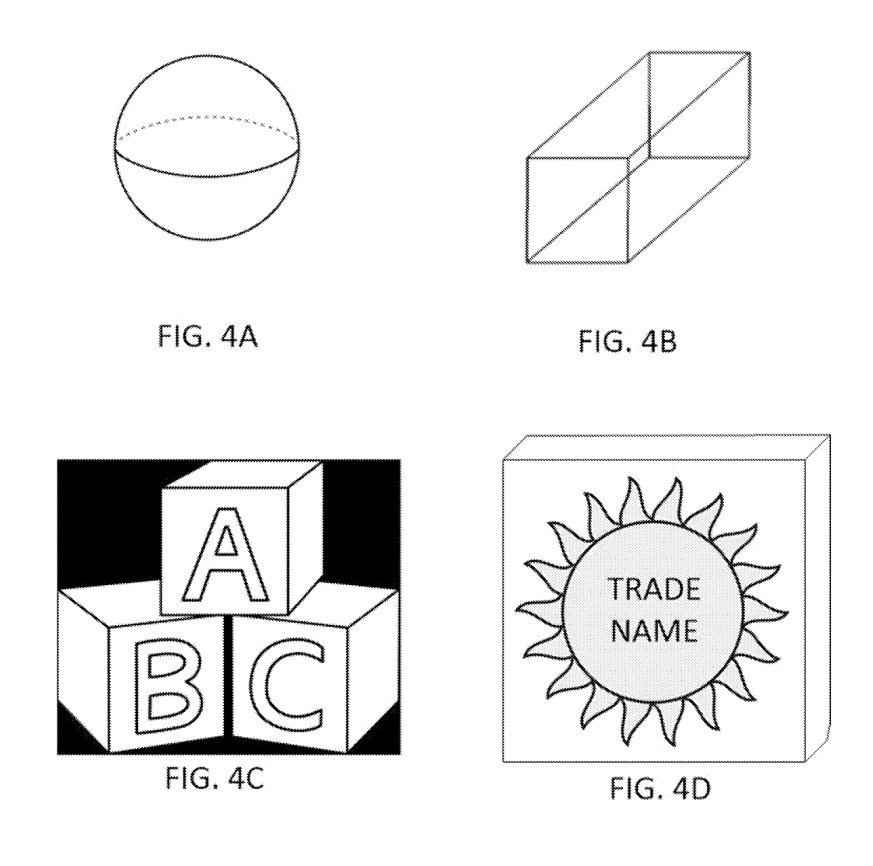

As shown in FIGS. 2 and 4A-D, the frozen compositions may be formed in the shape of a cube. It is also contemplated that the frozen compositions may take on the form of a sphere, cuboid, cylinder, hexagonal prism, cone, diamond, pyramid, triangular prism, or any other shape. For example, a cylinder may be formed having a hollow center, which increases the surface area to volume ratio and allows for quicker liquefaction. Rippled or bumpy surfaces may similarly provide means for causing certain frozen compositions or parts thereof to melt first. Also consistent with the present disclosure are frozen compositions that take on the shape of and/or resemble trade symbols, letters, words, names, or other marks commonly used to associate a product with a specific origin.

It is also contemplated that the freezing temperature may vary based on the composition being formed. For example, water-based liquids may have a higher freezing temperature than that of alcohol-based liquids. More specifically, the freezing point of water is 32 degrees Fahrenheit (F), whereas the freezing point of beer is approximately 28 degrees F. Additionally, 24- and 64-proof liquors freeze at 20 F and −10 F respectively. The frozen compositions must be packaged, stored, transported, and delivered at temperatures below their freezing temperature to maintain their solid state.

Consistent with the present disclosure are embodiments wherein additional additives, flavors, sweeteners, and dietary supplements may be included. For example, in an embodiment wherein a consumer is making a fruit smoothie, frozen compositions may be created having a protein powder, body enhancing supplements, vitamins, ginseng, green tea, caffeine boosts, or any other supplement commonly used in the art. Additionally, frozen compositions may be created having a sweetener such as sugar, aspartame, sucralose, or any off the shelf sweetener. In yet additional embodiments, frozen compositions may be created containing milk, cream, or non-dairy creamers. In such embodiments, the user could add any additional additive to meet his/her taste and/or texture preferences. As mentioned above, the presence of additives in a liquid may affect the temperature required to freeze the frozen compositions and maintain their predetermined volume and shape.

In one preferred embodiment, a first and second frozen composition have distinct concentrations of additives and combinations of shape and volume, or plurality thereof, such that when the frozen compositions are subsequently added to a specified amount of a liquid the effects of dilution on the beverage, or decrease in the amount of additives to the total volume of the liquid beverage, are minimized after a point in the liquefaction process.

Alternatively, if a consumer prefers an evolving change of taste or overall composition of an iced beverage during their drinking experience then a first and second frozen composition may have distinct combinations of additives and liquids, and combinations of shape and volume, or plurality thereof, such that when the frozen compositions are subsequently added to a specified amount of a liquid the taste of the liquid beverage evolves through a range of desired flavors after a point in the liquefaction process.

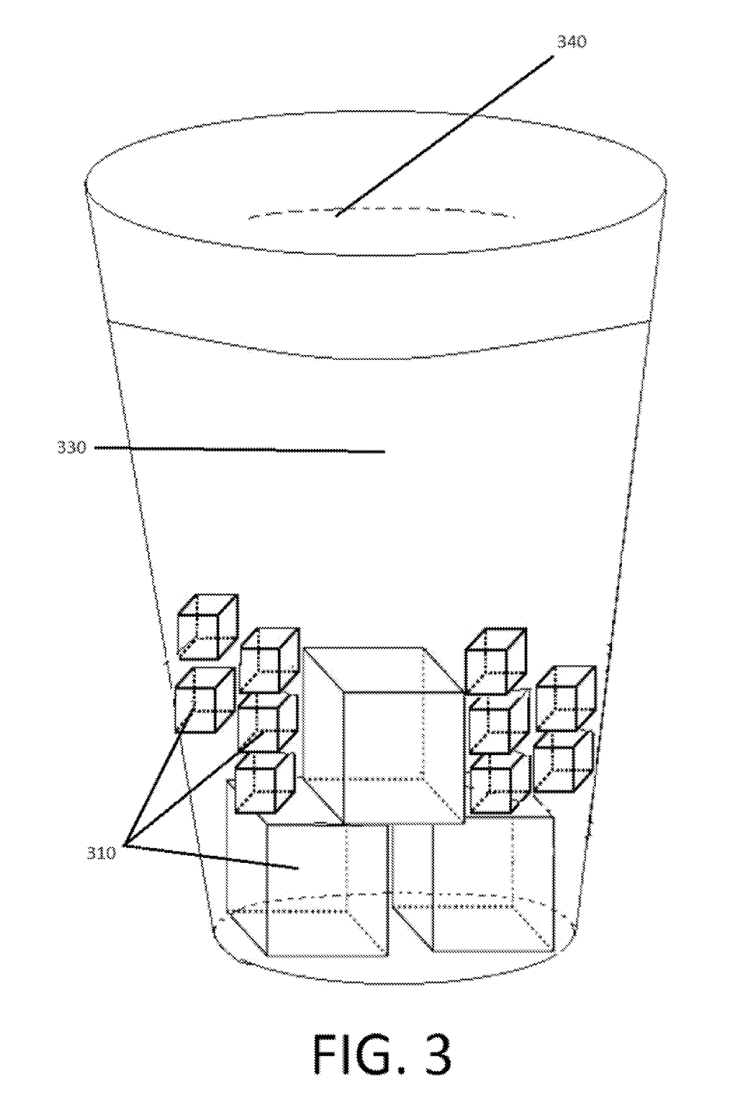

In additional embodiments, illustrated in FIG. 3, the frozen compositions 310 may be created and subsequently packaged and stored in a ready-to-use container 330 or cup. In such embodiments, the container 330 may further include a container portion 340 capable of being hermitically sealed. It is contemplated that the container portion 340 capable of being hermetically sealed may be placed near the bottom of the container, or in the alternative it may be placed at the top of the container, while in yet additional embodiments, the portion capable of being hermetically sealed may be located somewhere between the top and the bottom of the container. In at least one embodiment, the user would simply break the seal, remove any packaging materials, add water, and mix. In some embodiments, the container may be insulated and/or microwaveable. The container may further include lines drawn, formed, or contained thereon, for the purpose of informing the user how much of a liquid could/should be added.

In additional embodiments, the frozen compositions may be packaged in a manner so that when the packaging is opened and emptied into a container, the different frozen compositions naturally fall to the bottom of the container in a predetermined sequence.

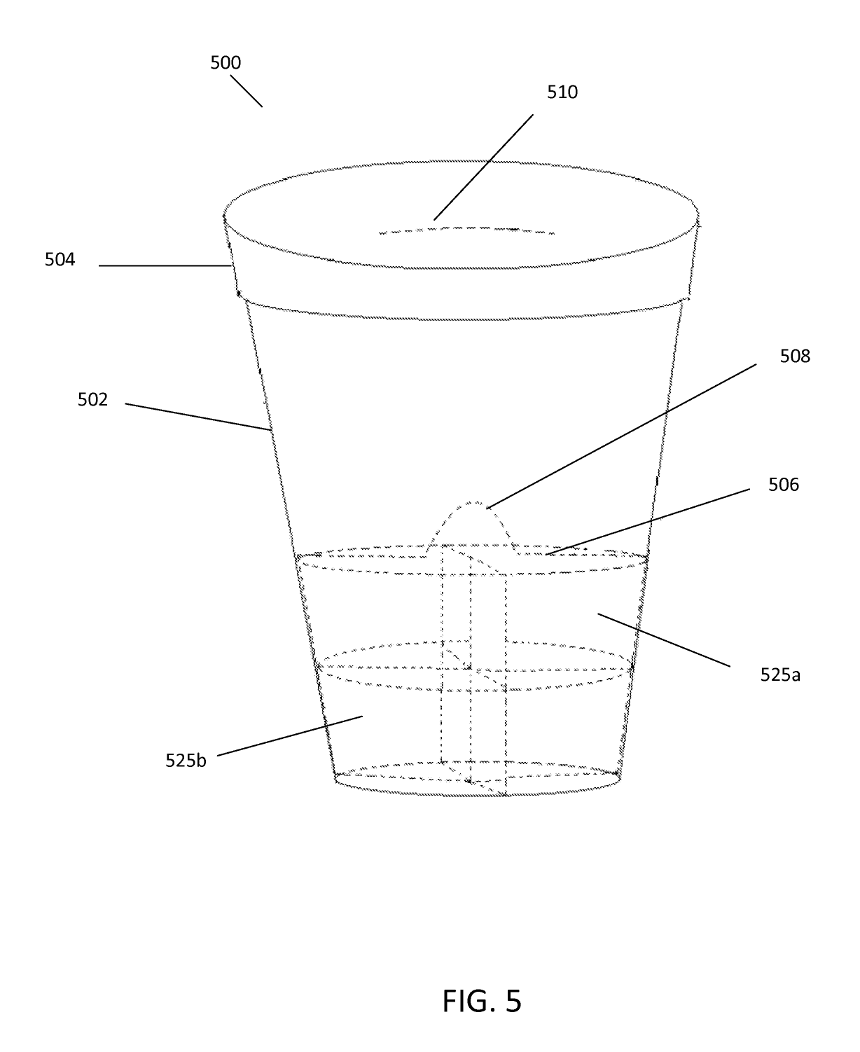

In additional embodiments, like in FIG. 5, the frozen compositions (525a and 525b) may be packaged with a divider and then thawed into a liquid within the same package or container. As shown, container 500 is comprised of a beverage cup 502 having a lid 504 and an internal divider 506 that separates compositions 525a and 525b in their frozen state (or liquid) states. A pull tab 508 aids in removing (or repositioning) the divider 506 so that when a liquid is added the compositions may begin to liquefy into the added liquid. Also shown is a volume or fill-to line 510 that may indicate a pre-determined amount of liquid to be added to the frozen compositions stored in container 500. In some variations the pull tab 508 removes a portion or lid from off the divider 506, which exposes the compositions to any liquid that is added into the beverage cup 502.

In these embodiments, the package or container may be shipped, distributed and stored in temperatures above the freezing point of the respective compositions while the divider prevents the compositions from mixing and allows them to maintain their unique combinations of shape and volume. The consumer may then freeze the packaged compositions and thereby re-freeze the frozen compositions. In additional embodiments, liquid states of the compositions may be created, packaged with a divider 506, distributed and stored in liquid form wherein the consumer may freeze the packaging and thereby make frozen compositions. In such embodiment, the divider prevents the compositions from mixing and allows them to freeze into their unique combinations of shape and volume.

### EXEMPLARY EMBODIMENTS CONSISTENT WITH THE PRESENT DISCLOSURE

Included are examples of beverages that can be created using the method taught and disclosed herein. These embodiments are included as examples of the disclosed method and are not intended to limit the scope of this disclosure.

### Embodiment (A)

A first composition with a higher concentration of additives, or higher concentrated composition, comprising 90 milliliters (mL) of cream, 30 grams (g) of coffee, and 21 g of sugar mixed with 30 mL of water, is frozen into cubic ice portions having a dimension of approximately 1 centimeter (cm)×1 cm×1 cm or smaller.

A second composition with a lower concentration of additives, or lower concentrated composition, comprising 30 mL of cream, 10 g of coffee, and 7 g of sugar mixed with 150 mL of water, is frozen into cubic ice portions having a dimension of approximately 4 cm×4 cm×4 cm or larger.

The frozen compositions with a higher and lower concentration of additives are packaged, stored, and distributed together below a specific temperature so that they maintain a solid form. The frozen compositions may then be added to 420 mL of water, the water having a temperature above the freezing point of the frozen compositions.

In such an embodiment, the ratio of an additive to another additive is equal in first and second composition. The freezing points of the frozen compositions may be depressed by their concentration of additives. For example, the smaller frozen compositions having a higher concentration of additives to total volume may melt faster than the larger frozen compositions having a lower concentration of additives to total volume in the same environment.

In at least one variation on Embodiment (A), the frozen compositions may provide for a just-add-water iced coffee and may be added to 420 mL of water. In such embodiments, the frozen composition with the higher concentration of additives, liquefied and mixed with the subsequently added 420 mL of water, is equal to the concentration of additives in the lower concentrated frozen composition. For example, the higher concentrated frozen composition includes 90 mL of cream for every 30 mL of water, while the lower concentrated frozen composition includes 3 mL of cream for every 15 mL of water. However, the frozen composition with the higher concentration of additives, liquefied and mixed with 420 mL of water, creates a new composition of 3 mL of cream for every 15 mL of water, the same ratio of cream to water in the frozen composition with the lower concentration of additives. If a composition with this specific concentration of additives is within the desired taste range of a consumer, then when the liquefaction of the frozen compositions into a subsequently added liquid produces this concentration of additives the consumer may enjoy the flavor of the created liquid beverage. Additionally, the frozen composition with the lower concentration of additives have a shape and volume that influences a longer duration for complete liquefaction, so this frozen composition may continue to melt and expel additives once a desired taste has been achieved. The frozen composition with the lower concentration of additives will keep the beverage cold while the release of additives during liquefaction will prevent the effects of dilution.

However, it is important to note, the ratios of additives (cream, coffee grounds, sugar, etc.) to one another in the frozen compositions do not need to be equal to mitigate dilution. As long as a frozen composition with at least one additive is configured to melt after a desired beverage has been achieved, then the dilution of at least one flavor will be mitigated. For example, the following Embodiment (B) lessens the effects of dilution.

### Embodiment (B)

A first composition with a higher concentration of additives, or higher concentrated composition, comprising 90 mL of cream, 30 g of coffee, and 21 g of sugar mixed into 30 mL of water, is frozen into a spherical ice portions having a surface area less than, or equal to, approximately 6 centimeters square (cm²).

A second composition with a lower concentration of additives, or lower concentrated composition, comprising 1 mL of cream, 1 g of coffee, and 1 g of sugar mixed into 150 mL of water, is frozen into spherical ice portions having a surface area greater than, or equal to, approximately 16 cm².

The higher concentrated and lower concentrated frozen compositions are packaged, stored, and distributed below a specific temperature so they maintain a solid form. The frozen compositions may then be added to 420 mL of water, the water having a predetermined temperature.

Some embodiments, like Embodiment (C), allow for the creation of a desired beverage, wherein the concentration of an additive increases after a desired flavor has been achieved during the liquefaction process.

### Embodiment (C)

A first composition with a higher concentration of additives, or higher concentrated composition, comprising 90 mL of cream, 30 g of coffee, and 21 g of sugar mixed into 30 mL of water, is frozen into cubic ice portions having a dimension greater than 5 cm×5 cm×5 cm.

A second frozen composition with a lower concentration of additives, or lower concentrated composition, comprising 60 mL of cream, 25 g of coffee, and 20 g of sugar mixed into 150 mL of water, is frozen into cubic ice portions having a dimension smaller than 1 cm×1 cm×1 cm.

The higher concentrated and lower concentrated frozen compositions are packaged, stored, and distributed below a specific temperature so they maintain a solid form. The frozen compositions may then be added to 420 mL of water, the water having a predetermined temperature.

In some embodiments, like Embodiment (D), the frozen compositions may be added to a range of volumes of a liquid and create a desired beverage with mitigated dilution effects.

### Embodiment (D)

A first composition with a higher concentration of additives, or higher concentrated composition, comprising 90 mL of cream, 30 g of coffee, and 21 g of sugar mixed with 30 mL of water, is frozen into cubic ice portions having a dimension of approximately 1 cm×1 cm×1 cm or smaller.

A second composition with a lower concentration of additives, or lower concentrated composition, comprising 30 mL of cream, 10 g of coffee, and 7 g of sugar mixed with 150 mL of water, is frozen into cubic ice portions having a dimension of approximately 4 cm×4 cm×4 cm or larger.

The higher concentrated and lower concentrated frozen compositions are packaged, stored, and distributed below a specific temperature so that they maintain a solid form. The frozen compositions may then be added to a volume of water between 300 mL and 600 mL, having a temperature above the freezing points of the frozen compositions.

Also consistent with the present disclosure are embodiments, like Embodiment (E), wherein separate additives of a desired beverage are frozen separately from one another, such that they may mix when liquefied. More specifically, the cream, coffee, sugar, flavoring, or any other additive may be frozen into its own respective frozen composition.

### Embodiment (E)

The different additives of a higher concentrated composition are frozen distinctly from each other into specific shapes and volumes, including 90 mL of cream frozen into spherical ice portions with a surface area less than 2 cm² (centimeters squared), 30 grams of coffee mixed with 15 mL of water frozen into cubic ice portions with a volume of 1 centimeters cubed (cm³) or smaller, and 21 grams of sugar mixed with 15 mL of water frozen into cubic ice portions with a volume of 2 cm³ or smaller.

The various additives of a different lower concentrated composition, including 60 mL of cream, 25 g of coffee, and 20 g of sugar, are mixed into 150 mL of water and subsequently frozen into cubic ice portions with a volume of 27 cm³; Or in the alternative, each of the additives that make-up the lower concentrated frozen composition may be frozen into their own respective individual frozen composition, as described above.

Each of the frozen compositions are packaged, stored, and distributed below a specific temperature so that they maintain a solid form. Before consumption the frozen compositions may be added to an amount of water based on the user's taste and flavoring preferences.

Also consistent with the present disclosure are methods for making a Daiquiri style beverage.

### Embodiment (F)

A first composition with a higher concentration of additives, or higher concentrated composition, comprising 60 mL of strawberry flavoring (strawberry juice, sugar, ect.), 30 mL of lime juice, and 20 mL of rum mixed with 40 mL of water, is frozen into spherical ice portions having a surface area less than, or equal to, 6 cm².

A second composition with a lower concentration of additives, or lower concentrated frozen composition, comprising 15 mL of strawberry flavoring, 7.5 mL of lime juice, and 5 mL of rum mixed with 120 mL of water, is frozen into spherical ice portions having a surface area greater than 6 cm².

The higher concentrated and lower concentrated frozen compositions are packaged, stored, and distributed below a specific temperature so they maintain a solid form. Before consumption the frozen compositions may be added to 440 mL of water, or another amount of water, within a previously determined temperature range.

In other embodiments, the liquid or liquids included in a composition, which may act as a solvent, may not be water. Additionally, the liquid subsequently added to the frozen ice portions to create a desired beverage experience may not be water. For example, the liquid may be any type of potable liquid. Also, the liquid subsequently added may be different than the liquid and additives in the frozen compositions. In further embodiments, the liquid that is not defined as an additive may be different in the first and second frozen compositions. In a further embodiment, a liquid may not be defined as an additive in a first frozen composition and may be defined as an additive in a second frozen composition.

Also contemplated herein are other/additional iced drinks, other/additional forms of flavoring, and other/additional types of alcohol that may be used to create margaritas, pina-coladas, and other commonly consumed iced or partially frozen beverages.

In some embodiments, a Daiquiri style beverage may be created by adding frozen compositions to rum.

### Embodiment (G)

A first composition, comprising 60 mL of strawberry flavoring and 30 mL of lime juice mixed with 120 mL of water, is frozen into ice cubes having a surface area less than, or equal to, 6 cm².

A second composition, comprising 15 mL of strawberry flavoring, 7.5 mL of lime juice and 30 mL of water mixed with 15 mL of rum, is frozen into ice cubes having a surface area greater than, or equal to, 27 cm².

The higher concentrated and lower concentrated frozen compositions are packaged, stored, and distributed below a specific temperature so that they maintain a solid form. Before consumption, the frozen compositions may be added to 60 mL of rum, the rum having a predetermined temperature range.

In such an embodiment, a frozen composition with alcohol may have a lower freezing point than a frozen composition with less or no alcohol. Therefore, the frozen composition with alcohol may melt at temperatures wherein the other frozen composition having less or no alcohol may remain solid. However, when the frozen compositions are added to a liquid environment above a certain temperature, (i.e., the freezing point of the frozen composition with little or no alcohol), the frozen composition with alcohol may have a shape and volume such that it completes liquefaction after the frozen composition with less or no alcohol.

In some embodiments frozen compositions may be hollow and/or may encapsulate other frozen compositions, thereby creating layered frozen compositions. Layered frozen compositions may be created by freezing a first composition into a specified combination of shape and volume. A second layer may then be created by freezing a different, second composition around the frozen first composition and thereby creating a singular solid with two distinct layered compositions. In additional embodiments, the process may be repeated to create additional layers. In embodiments having frozen, layered compositions, the frozen layered compositions may be added to a liquid and thereby create an iced beverage.

### Embodiment (H)

A first composition with a lower concentration of additives, or lower concentrated composition, comprising 15 mL of strawberry flavoring, 7.5 mL of lime juice and 5 mL of rum mixed with 120 mL of water, is frozen into spherical shape, or shapes, having a surface area of approximately 10 cm² or larger.

After the first composition is frozen into a solid form, a second, higher concentrated, composition, comprising 60 mL of strawberry flavoring, 30 mL of lime juice, and 20 mL of rum mixed with 40 mL of water, is frozen around the frozen solid, or solids, of the lower concentrated frozen composition, thereby encapsulating the lower concentrated composition. (As mentioned above, this same process may be repeated to create additional layers having either the same or varying compositions.)

The layered higher concentrated and lower concentrated frozen compositions are packaged, stored, and distributed below a specific temperature so that they maintain a solid form. Before consumption the layered frozen compositions may be added to 440 mL of water having a temperature within a predetermined range.

In such embodiments, the encapsulation and/or layering of frozen compositions may preserve the release of additives in encapsulated frozen compositions.

In some embodiments, the packaging method is not restricted to just two frozen compositions having two separate and distinct combinations of shape and volume. For example, it may be preferred to include three or more different frozen compositions with each having unique combinations of shape and volume.

### Embodiment (I)

A first composition with a high concentration of additives, or higher concentrated composition, comprising 90 mL of lemon juice, 15 g of sugar, and 9 g of tea leaves mixed with 30 mL of water, is frozen into cubic and spherical shapes having a surface area less than, or equal to, 8 cm².

A second composition with a lower concentration of additives, or lower concentrated composition, comprising 45 mL of lemon juice, 7.5 g of sugar, and 4.5 g of tea leaves mixed with 30 mL of water, is frozen into spherical and cubic shapes having a surface area greater than 12 cm², but less than 16 cm².

A third composition with a lowest concentration of additives, or lowest concentrated composition, comprising 30 mL of lemon juice, 5 g of sugar, and 3 g of tea leaves mixed with 150 mL of water, is frozen into cubic shapes having a volume greater than, or equal to, 3 cm³

The high concentrated composition, lower concentrated composition, and lowest concentrated composition are frozen, packaged, stored, and distributed below a specific temperature so they maintain a solid form. Before consumption the frozen compositions may be added to a volume of water having a temperature within a predetermined range.

As demonstrated in Embodiment (I) above, the ratio of an additive to another additive may be same in a plurality of compositions. However, the ratio of additives to another additive does not need to be constant in other embodiments and different compositions may have different combinations of additives. In such embodiments the proportionality and/or combination of additives in varying compositions may be altered so the taste of a beverage evolves through a range of desired flavors during the melting process. For example, one embodiment may have a stronger lemon flavor at the beginning of the melting process while a tea flavor increases as liquefaction continues.

### Embodiment (J)

A first composition having a high concentration of lemon, comprising 90 mL of lemon juice and 15 g of sugar mixed with 30 mL of water, is frozen into cubic ice portions having a volume less than 1 cm³.

A second composition with a high concentration of tea, comprising 5 mL of lemon juice, 5 g of sugar, and 9 g of tea leaves mixed with 150 mL of water, is frozen into spherical ice portions have a volume equal to 2 cm³.

The respective frozen compositions are packaged, stored, and distributed below a specific temperature so that they maintain a solid form. Before consumption the frozen compositions may be added to a volume of water having a temperature within a predetermined range.

As described herein, freezing a single composition, with at least on liquid and at least on additive, into ice portions with varying combinations of shape, volume, and surface area, and subsequently adding them to a liquid to create an iced beverage is within the scope of the present disclosure.

### Embodiment (K)

A single, first composition, comprising 90 milliliters (mL) of cream, 40 grams (g) of coffee, and 21 g of sugar mixed with 150 mL of water, is frozen into at least one cubic ice portion having a dimension of approximately 1 centimeter (cm)×1 cm×1 cm or smaller and frozen into at least one spherical ice portion having a surface area of 30 cm³.

The various frozen ice portions of the single composition are packaged, stored, and distributed below their freezing point. Before consumption the frozen composition, with varying combinations of shape, volume, and surface area, may be added to a volume of liquid having a temperature within a predetermined range.

The packaging method and embodiments described have many benefits, including the control of flavors during the liquefaction process. The above descriptions are merely illustrative. Having thus described several aspects of at least one embodiment of this invention including the preferred embodiments, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A beverage supplement comprising:
a first beverage enhancer comprised of at least one additive and at least one liquid, which together form a first composition, wherein the first composition is frozen; and
a second beverage enhancer comprised of at least one additive and at least one liquid, which together form a second composition, and
wherein the first and second beverage enhancers have varying compositions and are configured to melt into a beverage.

2. The beverage supplement of claim 1 wherein the composition of the first beverage enhancer and second beverage enhancer differ by their combination of additives and liquids.

3. The beverage supplement of claim 1, wherein the composition of the first beverage enhancer and second beverage enhancer differ in concentration.

4. The beverage supplement of claim 1, wherein the first beverage enhancer has a surface area configured to allow for quicker liquefaction than the second beverage enhancer.

5. The beverage supplement of claim 1, wherein the first beverage enhancer is further comprised of a plurality of frozen portions.

6. The beverage supplement of claim 1, wherein the first frozen composition forms a shape and volume that is different than the combination of shape and volume formed from the second frozen composition.

7. A beverage supplement comprising:
a first beverage enhancer comprised of a ratio of at least one additive and at least one liquid, which forms a first composition that is frozen; and
a second beverage enhancer comprised of a ratio of at least one additive and at least one liquid, which forms a second composition that is frozen; and
wherein the first and second compositions differ and are configured to melt into a beverage.

8. The beverage supplement of claim 7, wherein the frozen first and second beverage enhancer differ in volume.

9. The beverage additive of claim 7, wherein the frozen first and second beverage enhancer differ in surface area.

10. The beverage supplement of claim 7, wherein the frozen first and second beverage enhancer differ in shape.

11. A packaged beverage supplement comprising:
a container having first and second chambers,
wherein the first chamber is configured to store a first beverage enhancer comprised of an additive and liquid base,
wherein the second chamber is configured to store a second beverage enhancer comprised of an additive and liquid base having a composition that differs from the first beverage enhancer, and
wherein the container is configured to allow the first and second beverage enhancers to be frozen in the package.

12. The packaged beverage supplement of claim 11, further comprising a third chamber storing a third beverage enhancer comprised of an additive and liquid base.

13. The packaged beverage supplement of claim 11, further comprising a removable spacer separating the first and second chambers.

14. A beverage supplement comprising:
a first frozen beverage enhancer comprised of an additive and a liquid base that is encapsulated by a second frozen beverage enhancer comprised of an additive and liquid base, wherein the composition of the first and second beverage enhancers are different.

15. The beverage supplement of claim 14, further comprising a third beverage enhancer that is frozen and encapsulates the second and first beverage enhancers.

16. The beverage supplement of claim 14, wherein the first and second beverage enhancers form a plurality of layers formed over each other.

17. A method for packaging beverage supplements, comprising the steps of:
freezing a first beverage enhancer comprised of at least one additive and at least one liquid, thereby creating a first frozen composition;
freezing a second beverage enhancer comprised of at least one additive and at least one liquid, thereby creating a second frozen composition, wherein the first and second compositions differ; and
packaging the first and second frozen compositions in a beverage container.

18. The method of claim 17, further comprising the step of:
distributing the packages below the freezing point of the frozen compositions.

19. The method of claim 17, wherein the first beverage enhancer is configured to completely liquefy into a beverage faster than the second beverage enhancer.

20. The method of claim 17, wherein the beverage container has a removable insert separating a first and second chamber.

21. The method of claim 17, wherein the compositions of the first and second beverage enhancers vary in flavor.

22. A beverage supplement comprising:
a first composition comprised of an additive and a liquid base, wherein the first composition is frozen into a plurality of parts each part having a volume, and shape, with at least two of the frozen parts differing in combination of volume, and shape, and wherein the frozen parts are configured to melt into a beverage.
